(19) United States
(12) Patent Application Publication
(10) Pub. No.: US 2017/0341405 A1
(43) Pub. Date: Nov. 30, 2017

(54) LIQUID EJECTING APPARATUS

(71) Applicant: SEIKO EPSON CORPORATION, Tokyo (JP)

(72) Inventor: Akihiko MARUYAMA, Matsumoto (JP)

(21) Appl. No.: 15/607,170

(22) Filed: May 26, 2017

(30) Foreign Application Priority Data
May 27, 2016 (JP) 2016-106436

(51) Int. Cl. B41J 2/175; B41J 29/02; B41J 29/13; B41J 2/14

(52) U.S. Cl. CPC B41J 2/17556; B41J 29/02; B41J 2/17513; B41J 2/1755; B41J 2/17503; B41J 2/17553; B41J 29/13; B41J 2002/14346; B41J 2002/17516

(57) ABSTRACT

A liquid ejecting apparatus includes a liquid ejecting head that ejects liquid, supplied from a liquid supplier, toward a medium, an mounting portion on which the liquid supplier is removably mounted, and a supply channel that supplies the liquid from the mounting portion to the liquid ejecting head. The mounting portion has a frame forming an accommodating space capable of accommodating the liquid supplier, and the supply channel includes a portion disposed along the frame.

### BACKGROUND

### 1. Technical Field

The present invention relates to liquid ejecting apparatuses, such as printers.

### 2. Related Art

An example of the liquid ejecting apparatus is an ink jet printer, which performs printing by ejecting liquid (ink) from a liquid ejecting head to which the liquid is supplied via a liquid supply channel from a liquid cartridge that is installed in the printer. In such a printer, it is general practice to dispose a portion of the supply channel in the back of a space for accommodating the liquid cartridge (for example, JP-A-2004-330717).

However, disposing the supply channel in the back of the space for accommodating the liquid cartridge makes the depth of the printer longer and also the footprint of the printer larger.

Note that this problem is not specific to ink ejecting printers alone but is generally common among liquid ejecting apparatuses having a liquid supply channel.

### SUMMARY

An advantage of some aspects of the invention is that a liquid ejecting apparatus that can suppress an increase in footprint required for placement is provided.

Advantageous effects will now be described. According to an aspect of the invention, a liquid ejecting apparatus includes a liquid ejecting head that ejects liquid supplied from a liquid supplier toward a medium, an mounting portion in which the liquid supplier is removably installed, and a supply channel that supplies the liquid from the mounting portion to the liquid ejecting head. In the liquid ejecting apparatus, the mounting portion has a frame forming an accommodating space capable of accommodating the liquid supplier, and the supply channel includes a portion disposed along the frame.

According to this configuration, the mounting portion has the frame forming the accommodating space for the liquid supplier. Thus, although placement of the liquid ejecting apparatus requires at least the footprint that the frame occupies, disposing the supply channel for liquid along the frame can suppress the expansion of the footprint required for the placement.

It is preferable that the liquid ejecting apparatus further include a medium containing portion that contains the medium. The medium containing portion may be disposed at a position arranged in a vertical direction with respect to the frame, and the supply channel may include a portion disposed between the frame and the medium containing portion.

According to this configuration, disposing the supply channel in a gap formed between the medium containing portion and the frame allows space to be utilized efficiently. In the liquid ejecting apparatus, among a height, depth, and width of the liquid supplier with respect to an installation position of the liquid supplier when the liquid supplier is mounted on the mounting portion by being moved in a depth direction, it is preferable that the width be larger than the height. In addition, the mounting portion may allow a plurality of the liquid suppliers to be mounted in the mounting portion in such a manner that the plurality of the liquid suppliers are arranged in a width direction in the mounting portion.

According to this configuration, a plurality of the liquid suppliers, each having a width larger than its height, are mounted on the mounting portion in such a manner that the plurality of the liquid suppliers are arranged in the width direction, thereby preventing the height of the mounting portion from increasing. This can prevent the height of the apparatus from increasing even when a plurality of the liquid suppliers are installed.

In the liquid ejecting apparatus, it is preferable that a transport region where a transporting path for the medium is disposed and a side region outside the transporting path be arranged in a horizontal direction at a position arranged in a vertical direction with respect to the frame. In addition, the supply channel may include, in the side region, a turning portion at which a direction of flow of the liquid is changed from horizontal to vertical.

According to this configuration, disposing the turning portion of the supply channel, which changes the direction of flow of liquid from horizontal to vertical, requires a predetermined height, but disposing the turning portion in a side region that is positioned outside the transporting path for the medium allows the space lateral of the transporting path to be utilized efficiently.

In the liquid ejecting apparatus, it is preferable that the side region be disposed at each of two positions sandwiching the transport region, and the turning portion be disposed in either one of the two side regions. According to this configuration, the turning portion of the supply channel is disposed only in one of the two side region, which allows the other side region to be utilized for other purposes.

In the liquid ejecting apparatus, it is preferable that the side region be disposed at each of two positions sandwiching the transport region, and the turning portion be provided in both of the two side regions. According to this configuration, by disposing the turning portion of the supply channel in both of the two side regions, the supply channels can change direction at appropriate locations.

In the liquid ejecting apparatus, when a width direction is defined as a direction intersecting a movement path along which the liquid supplier moves in a depth direction so as to be mounted on the mounting portion, it is preferable that a transport region where a transporting path for the medium is disposed and a side region outside the transporting path be arranged in the width direction at a position arranged in a vertical direction with respect to the frame. In addition, a joint portion to which the supply channel is removably connected may be disposed in a front side in the side region in the depth direction.

According to this configuration, the joint portion is disposed in the front side in the side region, which allows maintenance work involving attachment/detachment of the supply channel to be carried out efficiently. In the liquid ejecting apparatus, it is preferable that a transport region where a transporting path for the medium is disposed and a side region outside the transporting path be arranged in a horizontal direction at a position arranged in a vertical direction with respect to the frame. In addition, a liquid reservoir capable of storing liquid midway along the supply channel may be disposed in the side region.

According to this configuration, disposing the liquid reservoir in the side region outside the transporting path for the medium allows the space lateral of the transporting path to be utilized efficiently. It is preferable that the liquid ejecting apparatus further include a supply mechanism formed so as to send the liquid from the liquid supplier to the supply channel. In addition, in the liquid ejecting apparatus, it is preferable that a transport region where a transporting path for the medium is disposed and a side region outside the transporting path be arranged in a horizontal direction at a position arranged in a vertical direction with respect to the frame. Moreover, at least a portion of the supply mechanism may be disposed in the side region.

According to this configuration, the supply mechanism that sends out liquid is disposed in the side region that is located outside the transporting path of the medium, which allows the space lateral of the transporting path to be utilized effectively.

It is preferable that the liquid ejecting apparatus include a container to be removably mounted on the mounting portion, and the liquid supplier be mounted on or removed from the mounting portion with the liquid supplier being held by the container. According to this configuration, by mounting or removing the liquid supplier in or from the mounting portion with the liquid supplier being held in the container, the liquid supplier can be replaced with the container being repeatedly reused.

### BRIEF DESCRIPTION OF THE DRAWINGS

The invention will be described with reference to the accompanying drawings, wherein like numbers reference like elements.

FIG. 1 is a perspective view illustrating a liquid ejecting apparatus according to an embodiment.

FIG. 2 is a front view illustrating an internal structure of the liquid ejecting apparatus in FIG. 1.

FIG. 3 is a perspective view illustrating an mounting portion included in the liquid ejecting apparatus in FIG. 1.

FIG. 4 is a plan view illustrating an internal structure of the liquid ejecting apparatus in FIG. 1.

FIG. 5 is a front view illustrating an internal structure of a liquid ejecting apparatus according to a first modification example.

FIG. 6 is a front view illustrating an internal structure of a liquid ejecting apparatus according to a second modification example.

FIG. 7 is a front view illustrating an internal structure of a liquid ejecting apparatus according to a third modification example.

### DESCRIPTION OF EXEMPLARY EMBODIMENTS

An embodiment of a liquid ejecting apparatus will be described with reference to the drawings. The liquid ejecting apparatus is, for example, an ink jet printer that performs recording (printing) by ejecting ink, which is an example of a liquid, onto a medium, such as a sheet of paper.

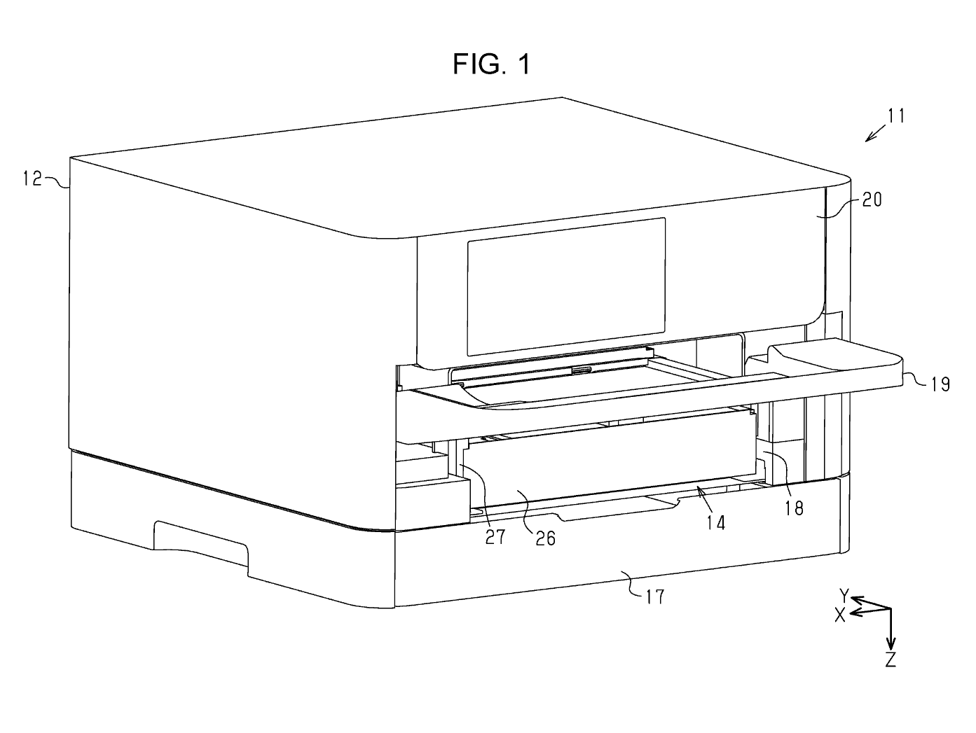

As illustrated in FIG. 1, a liquid ejecting apparatus 11 includes a housing 12 having a predetermined height, depth, and width when it is placed at a service location. On the front face of the housing 12, there are disposed, from bottom upward, a front cover 17, an installation opening 18, an output tray 19, and an operation panel 20. Note that the front face of the housing 12 is referred to as a side that has a height and width and that a user mainly works with to operate the liquid ejecting apparatus 11.

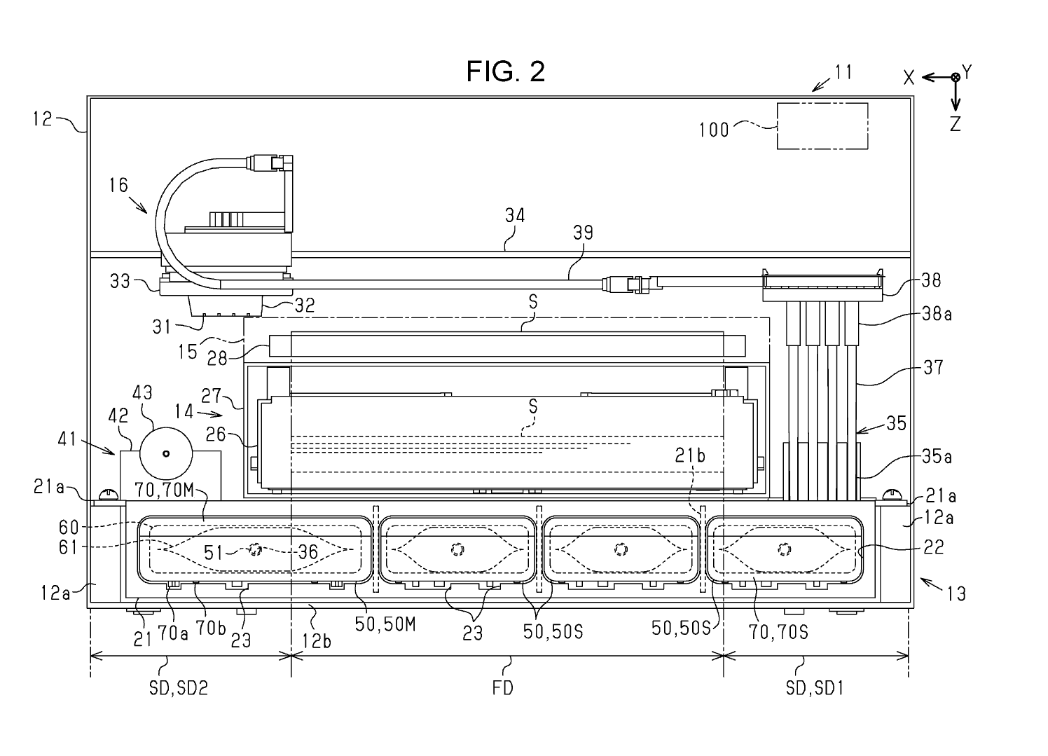

As illustrated in FIG. 1 and FIG. 2, there are disposed an mounting portion 13, a medium containing portion 14, a transport unit 15, and a recording unit 16, at positions inside the housing 12 in the rear of the front cover 17, the installation opening 18, the output tray 19, and the operation panel 20, respectively. In addition, the liquid ejecting apparatus 11 includes, at any position therein, a control unit 100 for controlling operation of the recording unit 16 and the like.

As illustrated in FIG. 2, the mounting portion 13 has a frame 21 forming an accommodating space capable of accommodating one or a plurality of mounting bodies 50 (four in the embodiment) and a connecting portion 36 disposed in the back of the accommodating space. The frame 21 also forms an insertion opening 22 that allows the front-face side to be in communication with the accommodating space. The mounting body 50 enters the accommodating space through the insertion opening 22 and moves in the depth direction along a movement path that extends toward the back. The mounting body 50 is thus mounted on the mounting portion 13.

In the embodiment, the width direction is defined as a direction intersecting (preferably orthogonally) the movement path of the mounting body 50 when being mounted on the mounting portion 13. The depth direction is defined as a direction extending along the movement path. In addition, both of the width direction and the depth direction extend substantially along a horizontal plane. In the drawings, the Z axis represents the gravitational direction, assuming that the housing 12 is placed on a horizontal plane, and the Y axis represents the movement direction when the mounting body 50 is being mounted on the mounting portion 13. The movement direction may also be described as the mounting direction toward the mounting portion 13 or as the insertion direction toward the accommodating space. The direction opposite the movement direction may be described as the taking-out direction. The width direction is also represented by the X axis that orthogonally intersects the Z axis and the Y axis. In other words, the width direction, the gravitational direction, and the mounting direction intersect each other (preferably orthogonally), and width, height, and depth are described with respect to these directions, respectively.

It is preferable that the housing 12 include support portions 12a that support the frame 21, which constitutes the mounting portion 13, at both ends in the width direction of the frame 21. The support portions 12a are preferably projected inwardly from both ends of the housing 12 in the width direction along a bottom plate portion 12b. It is also preferable that support protrusions 21a be provided at both ends of the frame 21 in the width direction in such a manner that the support protrusions 21a are projected from the peripheral edges of the frame 21 and are mounted on the support portion 12a.

In this case, it is more preferable that the support portions 12a of the housing 12 support the frame 21 via the support protrusions 21a in a manner to form a gap between the bottom of the frame 21 and the bottom plate portion 12b of the housing 12. Thereby, even when a small item, for example, a pen, gets caught under the bottom plate portion 12b and causes the bottom plate portion 12b to be warped upward, the deformation does not easily affect the frame 21. The support protrusions 21a may be secured to the support portions 12a by screws to fix the frame 21 to the housing 12.

The accommodating space formed by the frame 21 has a length in the width direction that is larger than that in the vertical direction. When it is viewed from the insertion opening 22 side, the accommodating space has a flat and horizontally spread shape. If a plurality of the mounting bodies 50 are mounted on the mounting portion 13, the accommodating space may be divided into respective spaces for the mounting bodies 50 or may be formed as one space capable of accommodating the plurality of the mounting bodies 50. It is also preferable that each of the divided accommodating spaces preferably have a length in the width direction that is larger than that in the vertical direction.

The mounting body 50 according to the embodiment includes a liquid supplier 60 that has a supply port 51, which is an outlet of liquid, and a liquid containing portion 61, which contains liquid. The mounting body 50 also includes a container 70 in which the liquid supplier 60 is put. In the state that the mounting body 50 is formed of the container 70 and the liquid supplier 60 that is held in the container 70, the liquid supplier 60 is removably mounted on the mounting portion 13 as the container 70 moves in the depth direction. The container 70 is formed so as to be removably mounted alone on the mounting portion 13 without holding the liquid supplier 60. The container 70 is a constituent included in the liquid ejecting apparatus 11.

With regard to the heights, depths, and widths of the container 70 and the liquid supplier 60 in their installation position when they are mounted on the mounting portion 13, it is preferable that their widths be larger than their heights. The shape of the container 70 may preferably be a drawer-like shape capable of storing the liquid supplier 60. However, the container 70 need not necessarily be capable of storing the whole portion of the liquid supplier 60. It is sufficient that the container 70 can hold and move the liquid supplier 60. Thus, the container 70 may be shaped like, for example, a tray on which the liquid supplier 60 can be placed.

The liquid containing portion 61 according to the embodiment is formed of a bag-like body having flexibility, and the supply port 51 is in communication with the inside of the liquid containing portion 61. In the embodiment, the liquid containing portions 61 in the four liquid suppliers 60 contain different types of liquid (for example, inks of different color, such as, black, cyan, magenta, and yellow.) Each liquid supplier 60 is inserted into the accommodating space through the insertion opening 22 with the liquid supplier 60 being held by the container 70. The liquid supplier 60 held by the container 70 is moved along the movement path in the mounting direction of the container 70, and the supply port 51 of the liquid supplier 60 is connected to the connecting portion 36 at the end of the movement path.

The connecting portion 36 is provided for each type of liquid to be used in the recording unit 16. When the supply port 51 of the liquid supplier 60 is connected to the connecting portion 36, the liquid contained in the liquid containing portion 61 is ready to be supplied to the liquid ejecting apparatus 11 through the connecting portion 36.

A plurality of the containers 70 having different widths can be mounted on the mounting portion 13 according to the embodiment in such a manner that the plurality of the containers 70 are arranged in the width direction. A plurality of the liquid suppliers 60 are also arranged, together with the containers 70, in the width direction. As the plurality of the containers 70, for example, more than three containers 70 including a first container 70S and a second container 70M that has a larger width than the first container 70S are mounted on the mounting portion 13. In this case, the second container 70M with the larger width is installed closer to an end in the width direction than the first container 70S. In the case that the containers 70 having different widths are mounted on the mounting portion 13, it is preferable that the insertion openings 22 be each formed in accordance with the width of each container 70. In addition, the connecting portions 36 are disposed in such a manner that the connecting portions 36 are arranged, in the width direction, with intervals therebetween that correspond to the widths of the respective containers 70 to be installed.

It is preferable that the frame 21 have a plurality of sets of one, or two or more linear guide rails 23 that are shaped convexly or concavely and extend in the depth direction to guide the movement of the container 70 when it is being attached/detached. Correspondingly, it is also preferable that rail engaging portions 70a be formed at the bottom of the container 70 to follow the convex or concave shapes of the guide rails 23. The guide rails 23 enable the movement path of the container 70 to be clearly defined when it is mounted on the mounting portion 13. When a plurality of the mounting bodies 50 or the containers 70 are installed into one accommodating space, the guide rails 23 enable the adjacent containers 70 to move without coming into unnecessary contact with each other.

The number of the guide rails 23 and the spacing therebetween in the width direction may be configured differently according to the width of each container 70 to be installed. In this case, the containers of the same width can use the same configuration of the rail engaging portion 70a so as to allow members to be used to be standardized. Alternatively, the number of the rails and the spacing therebetween in the width direction may be configured differently for each set of the guide rails 23 so as to prevent misinstallation of the container 70.

In addition, it is preferable that three or more leg portions 70b (four in the embodiment) be provided projecting from the bottom of the container 70 so as to keep the container 70 level. Thereby, the container 70 can be properly positioned in the vertical direction, which enables appropriate connection between the liquid supplier 60 and the connecting portion 36. The proper positioning of the container 70 enables the connection between the liquid supplier 60 and the connecting portion 36 to be maintained appropriately.

The medium containing portion 14 has a drawer-type media container 26 that contains media S and a guide frame 27 that guides the movement of the media container 26. The mounting portion 13 according to the embodiment has a width longer than that of the medium containing portion 14 in the width direction.

The transport unit 15 has a media supporting portion 28 that supports media S. The transport unit 15 takes out the media S contained in the medium containing portion 14 one by one, transports each of the media S forward, and places it on the media supporting portion 28. More specifically, the medium S is first taken out backward and diagonally upward from the medium containing portion 14. When the edge of the medium S that faces backward is bent further upward, the medium S is turned around so as to be transported from the rear to the front. The medium S is subsequently transported onto the media supporting portion 28. Thus, the transporting path for the medium S is disposed in a region at least extending from the medium containing portion 14 to the space above the media supporting portion 28 in the vertical direction. In the width direction, the transporting path is disposed in a region at least including the maximum width of the media S when, in the depth direction, it is disposed in a region extending from the space in the rear of the medium containing portion 14 to the output tray 19.

It is preferable that the media container 26 and the media supporting portion 28 be arranged in the vertical direction with respect to the frame 21. For example, in the embodiment, the media container 26 is disposed vertically above the frame 21, and the media supporting portion 28 is disposed vertically above the media container 26.

It is preferable that the width of the transporting path for the media S be made smaller than that of the frame 21 in the width direction, and then a transport region FD in which the transporting path for the media S is provided and side regions SD that are located outside the transporting path be arranged in the horizontal direction (preferably in the width direction) at a position arranged in the vertical direction with respect to the frame 21. It is also preferable that two side regions SD be provided at positions sandwiching the transport region FD in the width direction. When two side regions SD (SD1, SD2) are provided at positions sandwiching the transport region FD in the width direction, the medium containing portion 14 is preferably disposed near the center of the housing 12 in the width direction.

Note that the side regions SD according to the embodiment are indicated as spaces separated from the transport region FD in the width direction, and it is sufficient that each of the side regions SD is at least arranged in the vertical direction with respect to the frame 21. The vertical extent of the side regions SD is not specifically defined here.

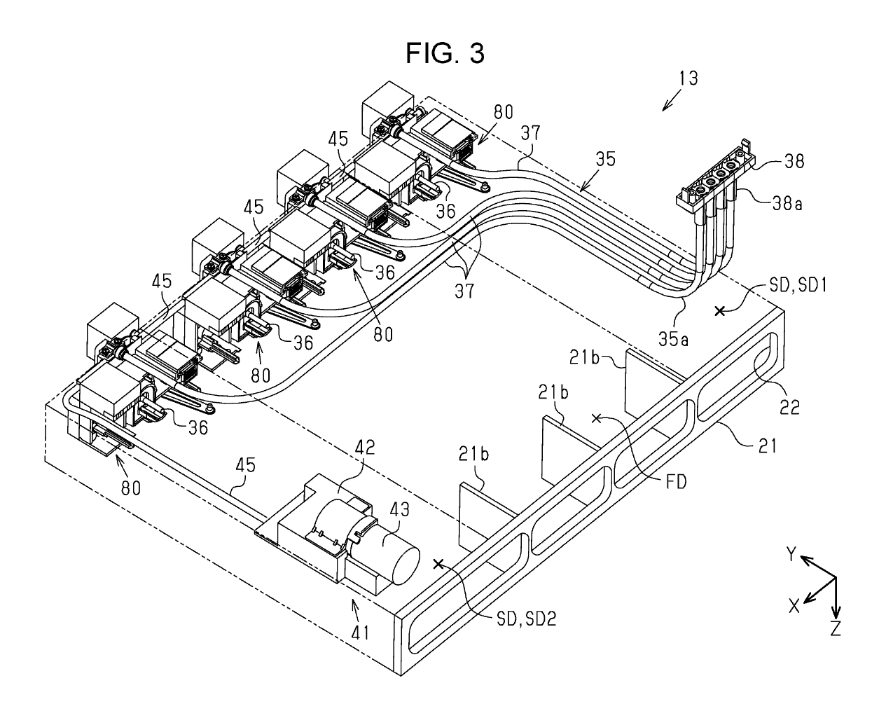

Partition walls 21b that partition the accommodating space in the width direction may be provided in the mounting portion 13 vertically below the medium containing portion 14. In the case that the guide rails 23 are provided in the mounting portion 13, the partition walls 21b may extend at least to a point in the depth direction where the container 70 is engaged with the guide rails 23 (also see FIG. 3). If the partition walls 21b are provided only in the vicinity of the insertion opening 22 as above, the structure of the mounting portion 13 can be simplified or made lighter. However, in the case that the liquid ejecting apparatus 11 has the medium containing portion 14 for containing media S and that the mounting portion 13 has the frame 21 forming the accommodating space capable of accommodating the container 70, the strength of the frame 21 that supports the medium containing portion 14 and the like, can be increased by extending the partition walls 21b deeper to the accommodating space.

The recording unit 16 includes a liquid ejecting head 32 with nozzles 31 that eject liquid and a carriage 33 holding the liquid ejecting head 32. A guide shaft 34 is disposed extending in the width direction inside the housing 12. The carriage 33 moves reciprocally along the guide shaft 34 in the width direction, and printing is performed in such a manner that, in the course of the reciprocal movement, the liquid ejecting head 32 ejects liquid onto a medium S placed on the media supporting portion 28.

In the embodiment, in the movement region in which the liquid ejecting head 32 moves in the width direction, the right-hand side in FIG. 2 is referred to as the home side and the left-hand side as the opposite home side. In this case, when the liquid ejecting head 32 does not move, it stands by at the end of the home side. Of the two side regions SD, the one on the home side is referred to as the side region SD1 and the other one on the opposite home side as the side region SD2.

The liquid ejecting apparatus 11 includes a supply channel 35 that supplies liquid from the mounting portion 13 toward the liquid ejecting head 32. It also includes a supply mechanism 41 formed so as to send the liquid contained in the liquid containing portion 61 of the liquid supplier 60 to the supply channel 35 via the supply port 51. The liquid ejecting head 32 then ejects the liquid, which is supplied from the liquid supplier 60 via the supply channel 35, onto the medium S.

As illustrated in FIG. 3, the mounting portion 13 includes connection mechanisms 80 disposed individually corresponding to each connecting portion 36 in the back of the accommodating space. The connection mechanism 80 is a mechanism that connects to the mounting body 50 (see FIG. 2).

The supply mechanism 41 includes, for example, a pressure varying mechanism 42 disposed in the side region SD2, a drive source 43 for the pressure varying mechanism 42, a pressure varying chamber (not shown) disposed in the back of the connecting portion 36, and a pressure varying channel 45 connecting the pressure varying mechanism 42 to the pressure varying chamber. Note that, in FIG. 3, only the vicinity of the front plate of the frame 21 that forms the insertion opening 22 is represented by solid lines.

The supply channel 35, which is provided for each type of liquid (each color in the embodiment), includes the connecting portion 36 that is the upstream end of the supply channel 35, a supply tube 37 having flexibility, a joint portion 38 to which the downstream end of the supply tube 37 is removably connected, and a displacement portion 39 (see FIG. 2) extending from the joint portion 38 to the carriage 33. The displacement portion 39 is, for example, flexible tubing in which a plurality of flow paths through which different types of liquid are to flow are arranged side by side. The displacement portion 39 is preferably bent and displaced so as to follow the movement of the carriage 33 (see FIG. 2).

A pump chamber (not shown) is provided between the connecting portion 36 and the supply tube 37. The downstream end of the connecting portion 36 and the upstream end of the supply tube 37 are in communication with the pump chamber. The pump chamber is separated by the flexible diaphragm (not shown) from the foregoing not-shown pressure varying chamber.

The pressure varying mechanism 42 decompresses the pressure varying chamber via the pressure varying channel 45 through the operation of the drive source 43 (for example, a motor), which causes the flexible diaphragm to be bent and displaced toward the pressure varying chamber. Thereby the pressure in the pump chamber drops. With this pressure drop in the pump chamber, the liquid contained in the liquid containing portion 61 is drawn to the pump chamber via the connecting portion 36. This is referred to as a suction operation. Subsequently, the pressure varying mechanism 42 releases the negative pressure in the pressure varying chamber via the pressure varying channel 45, which causes the flexible diaphragm to be bent and displaced toward the pump chamber. Thereby the pressure in the pump chamber rises. As the pressure in the pump chamber rises, the liquid within the pump chamber flows out, under pressure, to the supply tube 37. This is referred to as a discharge operation. By repeating the suction and discharge operations alternatingly, the supply mechanism 41 supplies liquid from the liquid supplier 60 (see FIG. 2) to the supply channel 35.

In the embodiment, a plurality of the pressure varying chambers and the pump chambers are provided with each corresponding to a type of liquid. The pressure varying mechanism 42 and the drive source 43 cause the pressure in the plurality of the pressure varying chambers to be changed via the pressure varying channel 45. Note that the pressure varying mechanism 42 may be formed so as to send pressurized gas to the pressure varying chamber via the pressure varying channel 45 through the operation of the drive source 43 to cause the flexible diaphragm to be bent and displaced toward the pump chamber to perform the discharge operation.

The joint portion 38 can be formed, for example, such that the joint portion 38 has a plurality of connection pipes 38a opening vertically downward and a plurality of the supply tubes 37 are removably connected to the connection pipes 38a. It is preferable that the joint portion 38 be provided in the front of the side region SD1 in the depth direction. It is also preferable that the supply channel 35 include a turning portion 35a that changes the direction of flow of liquid from horizontal to vertical in the side region SD1. Note that the turning portion 35a may be formed so as to have a joint portion 38 that has connection pipes 38a opening in the horizontal direction (for example, in the depth direction) and other connection pipes 38a opening in the vertical direction (for example, vertically upward).

The supply tube 37 and the pressure varying channel 45 include a portion disposed along the upper surface of the frame 21. For example, in the embodiment, four connecting portions 36 are arranged in the width direction in the rear of the insertion openings 22, and four supply tubes 37 connected to four respective connecting portions 36 are laid horizontally along the upper surface of the frame 21 and are gathered in the side region SD1. The downstream portions of the gathered supply tubes 37 turn vertically upward and are connected to the joint portion 38 disposed in the side region SD1. A portion of the pressure varying channel 45 also extends in the depth direction along the upper surface of the frame 21 in the side region SD2, and the subsequent portion bends and further extends in the width direction to be in communication with four pressure varying chambers.

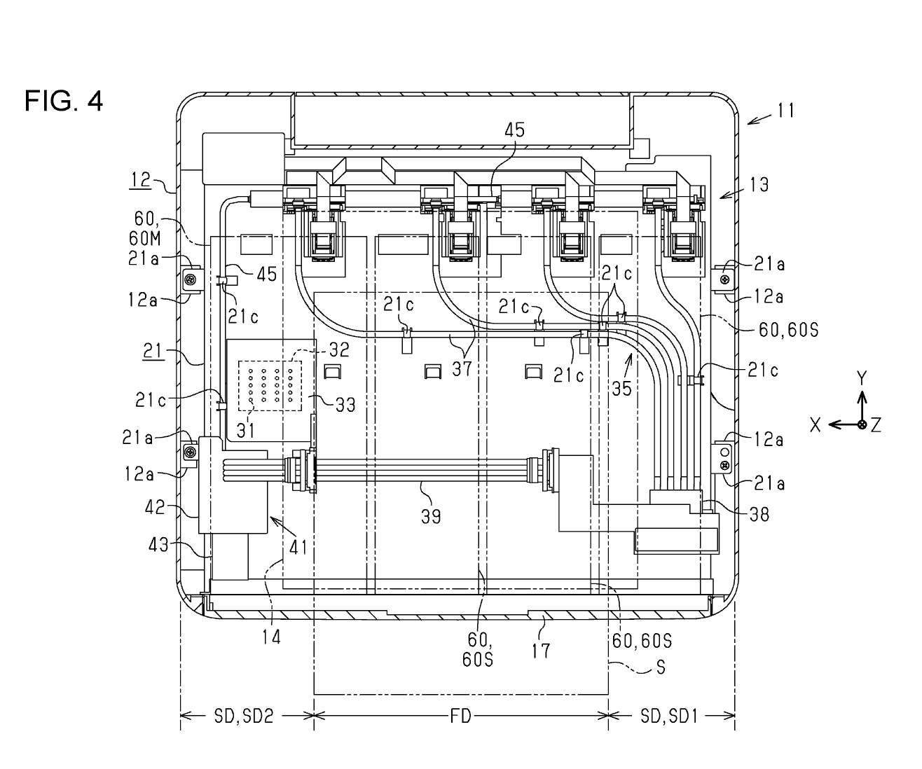

As illustrated in FIG. 4, the supply tubes 37 and the pressure varying channel 45 disposed along the upper surface of the frame 21 can be locked with locking portions 21c that project from the frame 21. Thereby, the supply tubes 37 and the pressure varying channel 45 can be moved together with the frame 21 when the supply tubes 37 are disconnected from the joint portion 38. Thus, the supply tubes 37 and the pressure varying channel 45 can be integrated into the frame 21 as one unit, which enables the whole unit to be mounted/dismounted for replacement.

In addition, it is preferable that the supply tubes 37 include a portion to be placed between the frame 21 and the medium containing portion 14. For example, in the embodiment, three supply tubes 37 except the home-side one among the four supply tubes 37 have curved portions laid along the upper surface of the frame 21 in the gap between the frame 21 and the medium containing portion 14 so as to reach the home side.

Note that a cover, which can be formed separately from or integrally with the front cover 17, may be removably attached in front of the joint portion 38 to facilitate attaching/detaching of the supply tubes 37 to and from the joint portion 38 when the cover is removed from the housing 12. Similarly, the pressure varying mechanism 42 and the drive source 43, which constitute the supply mechanism 41, may be disposed in the front of the side region SD2 and covered with a removable cover, which makes it easier to perform replacement, maintenance, or other work. Moreover, in the two side regions SD arranged in the width direction, the joint portion 38 and the turning portion 35a may be disposed in the side region SD1 while the supply mechanism 41 may be disposed in the side region SD2, thereby enabling maintenance or other work to be performed separately in each of the side regions SD1 and SD2.

Operation of the liquid ejecting apparatus 11 constituted as described above will now be described. In the liquid ejecting apparatus 11, the frame 21 accommodating the liquid suppliers 60 has a larger depth than the other elements. Thus, laying the supply channel 35 in the width direction in the rear of the connection mechanism 80 makes the apparatus even larger in depth.

However, the supply channel 35 according to the embodiment extends from the connecting portion 36, which is included in the mounting portion 13, to the upper surface of the frame 21 and further to the joint portion 38 along the frame 21, which hardly causes the required footprint of the apparatus to be larger in the depth direction. In addition, the space in the housing 12 can be efficiently utilized by disposing the joint portion 38 and the turning portion 35a in the side region SD1 located next to the medium containing portion 14 that is positioned between the recording unit 16 and the mounting portion 13 in the vertical direction, and also by disposing the supply mechanism 41 in the side region SD2.

According to the embodiment, the following effects can be obtained.

1) The mounting portion 13 has the frame 21 forming the accommodating space for the liquid suppliers 60. Thus, although placement of the liquid ejecting apparatus 11 requires at least the footprint that the frame 21 occupies, disposing the supply channel 35 for liquid along the frame 21 can suppress the expansion of the footprint required for the placement.

2) Disposing the supply channel 35 in a gap formed between the medium containing portion 14 and the frame 21 allows space to be utilized efficiently.

3) A plurality of the liquid suppliers 60, each having a width larger than its height, are mounted on the mounting portion 13 in such a manner that the plurality of the liquid suppliers 60 are arranged in the width direction, thereby preventing the height of the mounting portion 13 from increasing. This can prevent the height of the apparatus from increasing even when a plurality of the liquid suppliers 60 are installed.

4) Disposing the turning portion 35a of the supply channel 35, which changes the direction of flow of liquid from horizontal to vertical, requires a predetermined height, but disposing the turning portion 35a in a side region SD that is positioned outside the transporting path for the media S allows the space lateral of the transporting path to be utilized efficiently.

5) In the two side regions SD, the turning portion 35a of the supply channel 35 is disposed only in the side region SD1, which allows the other side region SD2 to be utilized for other purposes.

6) The joint portion 38 is disposed in the front of a side region SD, which allows maintenance work involving attachment/detachment of the supply channel 35 to be carried out efficiently.

7) The supply mechanism 41 for sending out liquid is disposed in a side region SD that is located outside the transporting path for the media S, which allows the space lateral of the transporting path to be utilized effectively.

8) Each of the liquid suppliers 60 is mounted on or removed from the mounting portion 13 with the liquid supplier 60 being held in the container 70, which allows the liquid supplier 60 to be replaced with the container 70 being reused repeatedly. Note that the embodiment may be altered into modification examples as described below. Moreover, the embodiment can be freely combined with modification examples below.

In the embodiment, in the two side regions SD arranged in the width direction, the joint portion 38 and the turning portion 35a are disposed in the side region SD1 while the supply mechanism 41 is disposed in the side region SD2. Conversely, the joint portion 38 and the turning portion 35a may be disposed in the side region SD2 while the supply mechanism 41 may be disposed in the side region SD1.

Alternatively, the turning portion 35a may be disposed in both of the two side regions SD. In this case, the joint portion 38 may also be disposed in both of the two side regions SD. For example, two supply channels 35 connected to a corresponding two of the liquid suppliers 60 on the home side may be extended to the side region SD1 and connected to the joint portion 38 via the turning portion 35a while two supply channels 35 connected to another corresponding two of the liquid suppliers 60 on the opposite home side may be extended to the side region SD2 and connected to the joint portion 38 via the turning portion 35a. Thus, by disposing the turning portion 35a of the supply channel 35 in both of the two side regions SD, the extended length of the supply channels 35 can be made shorter and the supply channels 35 can change direction at appropriate locations even in the case of installing a plurality of the liquid suppliers 60 that are arranged in the width direction.

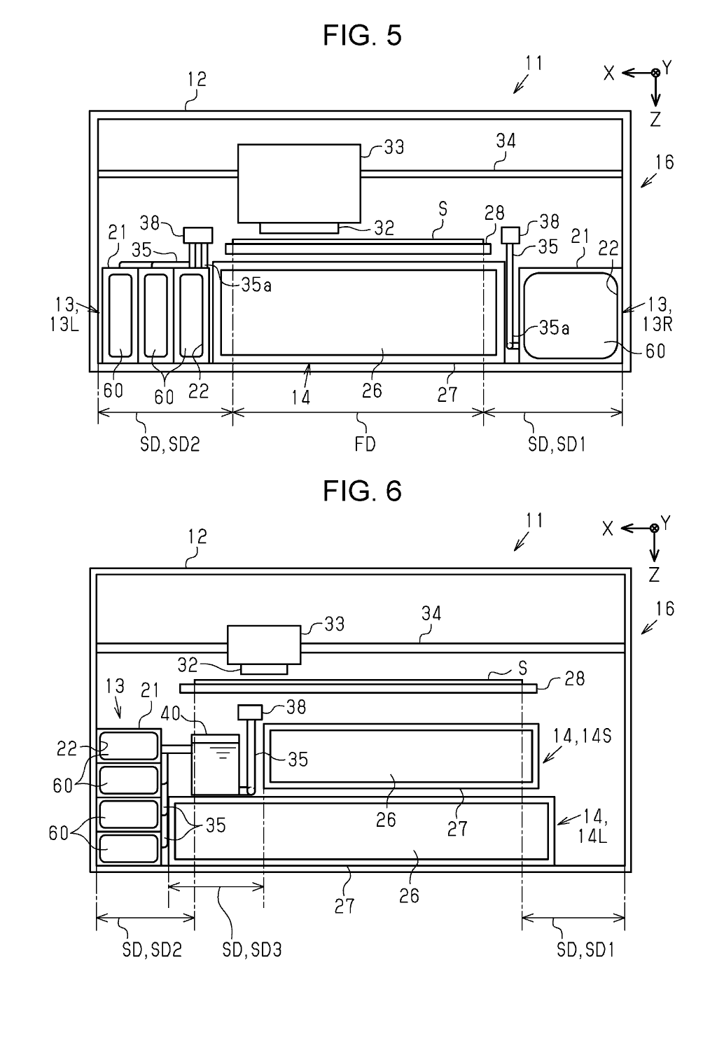

As in the first modification example illustrated in FIG. 5, the mounting portion 13 and the medium containing portion 14 may be arranged in the horizontal direction (for example, in the width direction). Note that the illustration of the displacement portion 39 is omitted in FIG. 5. In this case, the mounting portions 13 (13R, 13L) may be disposed at two positions that sandwich the medium containing portion 14 and are arranged in the width direction. Thus, a plurality (for example, three) of the liquid suppliers 60 may be mounted on one mounting portion 13L when one of the liquid suppliers 60 may be mounted on the other mounting portion 13R (for example, on the home side).

In addition, in this case, a portion of the supply channel 35 may be disposed in a gap formed between the mounting portion 13R and the medium containing portion 14, or otherwise may be disposed along outer surfaces of the mounting portion 13R. Moreover, the joint portion 38 and the turning portion 35a may be provided in each of the two side regions SD. Further, the accommodating space for accommodating the liquid suppliers 60 may have equal width and height as is similar to the mounting portion 13R, or the height may be larger than the width as is similar to the mounting portion 13L.

The side region SD may be provided either on the home side or on the opposite home side of the transporting path. As in the second modification example illustrated in FIG. 6, the accommodating space for accommodating each of the liquid suppliers 60 in the mounting portion 13 may be provided in such a manner that a plurality of the accommodating spaces are arranged in the vertical direction. Note that the illustration of the displacement portion 39 is omitted in FIG. 6.

As in the second modification example illustrated in FIG. 6, the liquid ejecting apparatus 11 may include a plurality of medium containing portions 14 (14S, 14L) for containing media S having different widths. In this case, the medium containing portions 14S and 14L may be arranged in the vertical direction, and the mounting portion 13 or the supply channel 35 may be disposed in a side region SD (SD3), which is a region vertically adjacent to the medium containing portion 14L with a larger width and where the medium containing portion 14S with a smaller width is not provided.

In this case, a liquid reservoir 40 capable of storing liquid midway along the supply channel 35 may also be disposed in the side region SD3. Note that the liquid reservoir 40 can be disposed in the side region SD1 or in the side region SD2. Disposing the liquid reservoir 40 in a side region SD outside the transporting path for media S allows the space lateral of the transporting path to be utilized efficiently. In this case, the liquid reservoir 40 can be formed so as to have a connecting portion to which the supply tube 37 that constitutes the supply channel 35 is removably connected, and the connecting portion can be formed so as to be utilized as the joint portion 38 or the turning portion 35a. Allowing another member to be utilized as the joint portion 38 or the turning portion 35a as such can reduce the number of components.

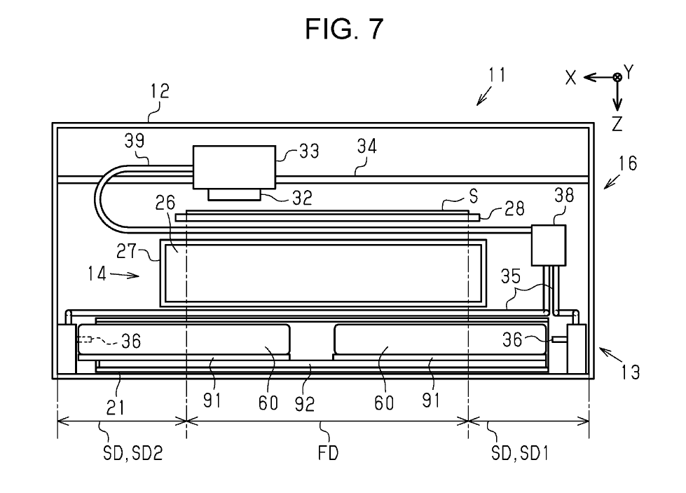

As in the third modification example illustrated in FIG. 7, the mounting portion 13 may include the connecting portions 36 extending in the width direction so that the liquid suppliers 60 are installed by moving them in the width direction. In this case, first trays 91 and a second tray 92 are used. The first trays 91 move in the width direction with the liquid suppliers 60 being mounted thereon and the second tray 92 moves along the depth direction with the first trays 91 being mounted thereon. The second tray 92, which carries the first trays 91 and the liquid suppliers 60, is first moved in the depth direction and inserted in the accommodating space, and then the first trays 91, which carry the liquid suppliers 60, are moved in the width direction to connect the liquid suppliers 60 to the connecting portions 36. In the case that the insertion direction toward the accommodating space (the movement direction of the second tray 92) is different, as such, from the mounting directions of the liquid suppliers 60 (the movement directions of the first trays 91), the supply channels 35 change direction at both end sides in the width direction, extend along the frame 21, and are connected to the joint portion 38.

The mounting portion 13, the medium containing portion 14, and the recording unit 16 can be arranged in any order in the vertical direction. For example, the mounting portion 13 may be disposed vertically above the recording unit 16, or otherwise may be disposed vertically above the medium containing portion 14. In this case, the supply channel 35 is preferably laid along a lower surface (bottom surface) of the frame 21. In addition, the direction of flow of liquid may be changed from horizontal to vertical at the turning portion 35a of the supply channel 35. Moreover, another apparatus, such as an image reading apparatus, may be attached vertically above the housing 12.

Each of the liquid suppliers 60 may be removably mounted on the mounting portion 13 without the liquid supplier 60 being held by the container 70. For example, the liquid supplier 60 may be formed such that it includes a case having rigidity and the case contains a flexible liquid containing portion 61 containing liquid. Alternatively, the case having rigidity may directly contain liquid. In this case, the supply mechanism 41 can be formed so as to send pressurized gas into the case to cause the liquid in the case to be sent to the supply channel 35.

The liquid supplier 60 may be an adapter which does not include the liquid containing portion 61 for containing liquid but includes a supply channel that is in communication with the supply port 51. In this case, by connecting the supply channel to a liquid containing portion (such as a tank for containing liquid) that is provided outside the housing 12, liquid can be provided from the liquid containing portion outside the housing 12 to the liquid ejecting head 32 via the supply channel 35. With this configuration, the volume of the housing 12 does not limit the size of the liquid containing portion, which allows the liquid containing portion to be made larger to eject more liquid continuously.

In the case that the liquid supplier 60 is the adapter that does not include the liquid containing portion 61, the container 70 or the liquid supplier 60 may have a depth smaller than the width when the height, depth, and width are defined with respect to the installation position of the container 70 or the liquid supplier 60. In addition, the mounting portion 13 may accept both of a liquid supplier 60 as the adapter that does not include the liquid containing portion and a liquid supplier 60 as the liquid container.

The liquid containing portion 61 need not have a bag-like body having flexibility but may have, for example, a box-like body (tank) having rigidity. In this case, a fill port may be provided in the box-like body. Liquid may be supplied to the liquid containing portion 61 through this fill port, or alternatively liquid may be supplied to the liquid containing portion 61 by connecting a tube to this fill port.

The liquid that the liquid ejecting head ejects is not limited to ink but may be, for example, a liquid-state material made by dispersing or mixing particles of a functioning material in liquid. For example, the liquid ejecting apparatus 11 can be formed so as to record by ejecting a liquid-state material that contains, in the form of a dispersion or melt, an electrode material, a coloring material (pixel material), and the like, to be used, for example, for manufacturing liquid crystal displays, Electro Luminescence (EL) displays, surface light emission displays.

The medium S is not limited to a sheet of paper but may be a plastic film, a thin board material, or may be a piece of cloth to be used for a cloth-printing apparatus and the like. Moreover, the medium S need not only be a cut sheet cut into a predetermined dimension but may be, for example, a medium wound in a roll, or may be a piece of clothing or the like having any shape, such as a T-shirt, or may be a three-dimensional object having any shape, such as a piece of tableware or stationery.

The entire disclosure of Japanese Patent Application No. 2016-106436, filed May 27, 2016 is expressly incorporated by reference herein.

What is claimed is:

1. A liquid ejecting apparatus, comprising:
a liquid ejecting head that ejects liquid, supplied from a liquid supplier, toward a medium;
an mounting portion on which the liquid supplier is removably mounted; and
a supply channel that supplies the liquid from the mounting portion to the liquid ejecting head,
wherein the mounting portion has a frame forming an accommodating space capable of accommodating the liquid supplier, and
wherein the supply channel includes a portion disposed along the frame.

2. The liquid ejecting apparatus according to claim 1, further comprising a medium containing portion that contains the medium,
wherein the medium containing portion is disposed at a position arranged in a vertical direction with respect to the frame, and
wherein the supply channel includes a portion disposed between the frame and the medium containing portion.

3. The liquid ejecting apparatus according to claim 1,
wherein, among a height, depth, and width of the liquid supplier with respect to an installation position of the liquid supplier when the liquid supplier is mounted on the mounting portion by being moved in a depth direction, the width is larger than the height, and
wherein the mounting portion allows a plurality of the liquid suppliers to be mounted on the mounting portion in such a manner that the plurality of the liquid suppliers are arranged in a width direction in the mounting portion.

4. The liquid ejecting apparatus according to claim 1,
wherein a transport region where a transporting path for the medium is disposed and a side region outside the transporting path are arranged in a horizontal direction at a position arranged in a vertical direction with respect to the frame, and
wherein the supply channel includes, in the side region, a turning portion at which a direction of flow of the liquid is changed from horizontal to vertical.

5. The liquid ejecting apparatus according to claim 4, wherein the side region is disposed at each of two positions sandwiching the transport region, and the turning portion is disposed in either one of the side regions.

6. The liquid ejecting apparatus according to claim 4, wherein the side region is disposed at each of two positions sandwiching the transport region, and the turning portion is provided in both of the side regions.

7. The liquid ejecting apparatus according to claim 1,
wherein, when a width direction is defined as a direction intersecting a movement path along which the liquid supplier moves in a depth direction so as to be mounted on the mounting portion, a transport region where a transporting path for the medium is disposed and a side region outside the transporting path are arranged in the width direction at a position arranged in a vertical direction with respect to the frame, and
wherein a joint portion to which the supply channel is removably connected is disposed in a front side in the side region in the depth direction.

8. The liquid ejecting apparatus according to claim 1,
wherein a transport region where a transporting path for the medium is disposed and a side region outside the transporting path are arranged in a horizontal direction at a position arranged in a vertical direction with respect to the frame, and
wherein a liquid reservoir capable of storing liquid midway along the supply channel is disposed in the side region.

9. The liquid ejecting apparatus according to claim 1, further comprising a supply mechanism formed so as to send the liquid from the liquid supplier to the supply channel,
wherein a transport region where a transporting path for the medium is disposed and a side region outside the transporting path are arranged in a horizontal direction at a position arranged in a vertical direction with respect to the frame, and at least a portion of the supply mechanism is disposed in the side region.

10. The liquid ejecting apparatus according to claim 1, further comprising a container to be removably mounted on the mounting portion, wherein the liquid supplier is mounted on or removed from the mounting portion with the liquid supplier being held by the container.
